(19) United States
(12) Patent Application Publication
(10) Pub. No.: US 2012/0327077 A1
(43) Pub. Date: Dec. 27, 2012

(54) APPARATUS FOR RENDERING 3D IMAGES

(76) Inventor: Hsu-Jung TUNG, Zhubei City (TW)

(21) Appl. No.: 13/527,281

(22) Filed: Jun. 19, 2012

(30) Foreign Application Priority Data
Jun. 22, 2011 (TW) 100121900

(51) Int. Cl. G06T 15/00

(52) U.S. Cl. 345/419

(57) ABSTRACT

A 3D image rendering apparatus is disclosed including: an image receiving device for receiving a left-eye image and a right-eye image; a depth calculator, coupled with the image receiving device, for generating a corresponding left-eye depth map and/or a right-eye depth map according to the left-eye image and the right-eye image; a command receiving device for receiving a depth adjusting command; and an image rendering device, coupled with the command receiving device, for increasing the depth value of a first pixel in the left-eye depth map and/or the right-eye depth map and reducing the depth value of a second pixel in the left-eye depth map and/or the right-eye depth map.

### CROSS-REFERENCE TO RELATED APPLICATIONS

This application claims the benefit of priority to Taiwanese Patent Application No. 100121900, filed on Jun. 22, 2011; the entirety of which is incorporated herein by reference for all purposes.

### BACKGROUND

The present disclosure generally relates to 3D image display technology and, more particularly, to 3D image rendering apparatuses capable of adjusting depth of 3D image objects.

With the technology progress, 3D image display application has become more and more popular. When producing 3D stereo visual effect, some 3D image rendering technologies require additional devices, such as specialized glasses or helmet, and other technical solutions need not. The 3D image rendering technologies provide more stereo visual effect, but different observers have different sensitivity and perception. Therefore, same 3D image may be found not stereo enough to some people, but may cause dizziness to other people.

Unfortunately, due to the limitation on the format of source image data or transmission bandwidth, the traditional 3D image display system is unable to allow the users to adjust the depth configuration of 3D images depending upon their visual perception, and thus not able to provide desirable viewing quality or may cause the observers to feel uncomfortable when viewing 3D images.

### SUMMARY

In view of the foregoing, it can be appreciated that a substantial need exists for apparatuses that can allow the observer to adjust the depth configuration of 3D images depending upon their visual perception.

A 3D image rendering apparatus is disclosed comprising: an image receiving device for receiving a first left-eye image and a first right-eye image capable of forming a first 3D image, wherein a first image object of the first left-eye image and a second image object of the first right-eye image are for forming a first 3D image object in the first 3D image, and a third image object of the first left-eye image and a fourth image object of the first right-eye image are for forming a second 3D image object in the first 3D image; a command receiving device for receiving a depth adjusting command; and an image rendering device, coupled with the command receiving device, for adjusting positions of the first, second, third, and fourth image objects according to the depth adjusting command to generate a second left-eye image and a second right-eye image for forming a second 3D image, so that the first image object and the second image object forms a third 3D image object in the second 3D image, and the third image object and the fourth image object forms a fourth 3D image object in the second 3D image; wherein depth of the third 3D image object in the second 3D image is greater than depth of the first 3D image object in the first 3D image, and depth of the fourth 3D image object in the second 3D image is lighter than depth of the second 3D image object in the first 3D image.

Another 3D image rendering apparatus is disclosed comprising: an image receiving device for receiving a first left-eye image and a first right-eye image capable of forming a first 3D image, wherein a first image object of the first left-eye image and a second image object of the first right-eye image are for forming a first 3D image object in the first 3D image, and a third image object of the first left-eye image and a fourth image object of the first right-eye image are for forming a second 3D image object in the first 3D image; a command receiving device for receiving a depth adjusting command; and an image rendering device, coupled with the command receiving device, for adjusting positions of only a portion of image objects in the first left-eye image and the first right-eye image according to the depth adjusting command to generate a second left-eye image and a second right-eye image for forming a second 3D image, so that the first image object and the second image object forms a third 3D image object in the second 3D image, and the third image object and the fourth image object forms a fourth 3D image object in the second 3D image; wherein depth of the third 3D image object in the second 3D image is different from depth of the first 3D image object in the first 3D image, and depth of the fourth 3D image object in the second 3D image is equal to depth of the second 3D image object in the first 3D image.

Yet another 3D image rendering apparatus is disclosed comprising: an image receiving device for receiving a left-eye image and a right-eye image; a depth calculator, coupled with the image receiving device, for generating a depth map according to the left-eye image and the right-eye image; and an image rendering device for synthesizing a plurality of left-eye images and a plurality of right-eye images respectively corresponding to a plurality of viewing points according to the left-eye image, the right-eye image, and the depth map.

Yet another 3D image rendering apparatus is disclosed comprising: an image receiving device for receiving a left-eye image and a right-eye image; a depth calculator, coupled with the image receiving device, for generating at least one of a left-eye depth map and a right-eye depth map according to the left-eye image and the right-eye image; a command receiving device for receiving a depth adjusting command; and an image rendering device, coupled with the command receiving device, for increasing a depth value of a first pixel in at least one of the left-eye depth map and the right-eye depth map and for reducing a depth value of a second pixel in at least one of the left-eye depth map and the right-eye depth map.

Yet another 3D image rendering apparatus is disclosed comprising: an image receiving device for receiving a first left-eye image and a first right-eye image capable of forming a first 3D image, wherein a first image object of the first left-eye image and a second image object of the first right-eye image are for forming a first 3D image object in the first 3D image, and a third image object of the first left-eye image and a fourth image object of the first right-eye image are for forming a second 3D image object in the first 3D image; a command receiving device for receiving a depth adjusting command; and an image rendering device, coupled with the command receiving device, for adjusting positions of at least a portion of image objects in the first left-eye image and the first right-eye image according to the depth adjusting command to generate a second left-eye image and a second right-eye image for forming a second 3D image, so that the first image object and the second image object forms a third 3D image object in the second 3D image, and the third image object and the fourth image object forms a fourth 3D image object in the second 3D image; wherein depth difference between the third 3D image object and the fourth 3D image object in the second 3D image is different from depth difference between the first 3D image object and the second 3D image object in the first 3D image.

Yet another 3D image rendering apparatus is disclosed comprising: an image receiving device for receiving a left-eye image and a right-eye image; a depth calculator, coupled with the image receiving device, for generating at least one of a left-eye depth map and a right-eye depth map according to the left-eye image and the right-eye image; a command receiving device for receiving a depth adjusting command; and an image rendering device, coupled with the command receiving device, for adjusting depth values of at least a portion of pixels in the left-eye depth map and the right-eye depth map so that a change in depth value of a first pixel in at least one of the left-eye depth map and the right-eye depth map is different from that of a second pixel in at least one of the left-eye depth map and the right-eye depth map.

It is to be understood that both the foregoing general description and the following detailed description are example and explanatory only and are not restrictive of the invention, as claimed.

### BRIEF DESCRIPTION OF THE DRAWINGS

FIG. 1 is a simplified functional block diagram of a 3D image rendering apparatus according to an example embodiment.

FIG. 2 is a simplified flowchart illustrating a method for rendering 3D image in accordance with an example embodiment.

FIG. 3 is a simplified schematic diagram of a left-eye image and a right-eye image received by the 3D image rendering apparatus of FIG. 1 according to an example embodiment.

FIG. 4 is a simplified schematic diagram of a left-eye depth map and a right-eye depth map generated by the 3D image rendering apparatus of FIG. 1 according to an example embodiment.

FIG. 5 is a simplified schematic diagram of a left-eye image and a right-eye image generated by the 3D image rendering apparatus of FIG. 1 according to an example embodiment.

FIG. 6 is a simplified schematic diagram illustrating the operation of adjusting depth of 3D images performed by the 3D image rendering apparatus of FIG. 1 according to an example embodiment.

FIG. 7 is a simplified schematic diagram of a left-eye image and a right-eye image generated by the 3D image rendering apparatus of FIG. 1 according to another example embodiment.

### DETAILED DESCRIPTION

Reference will now be made in detail to embodiments of the invention, which are illustrated in the accompanying drawings.

The same reference numbers may be used throughout the drawings to refer to the same or like parts or components. Certain terms are used throughout the description and following claims to refer to particular components. As one skilled in the art will appreciate, a component may be referred by different names. This document does not intend to distinguish between components that differ in name but not in function. In the following description and in the claims, the term “comprise” is used in an open-ended fashion, and thus should be interpreted to mean “include, but not limited to . . . .” Also, the phrase “coupled with” is intended to compass any indirect or direct connection. Accordingly, if this document mentioned that a first device is coupled with a second device, it means that the first device may be directly or indirectly connected to the second device through electrical connections, wireless communications, optical communications, or other signal connections with/without other intermediate devices or connection means.

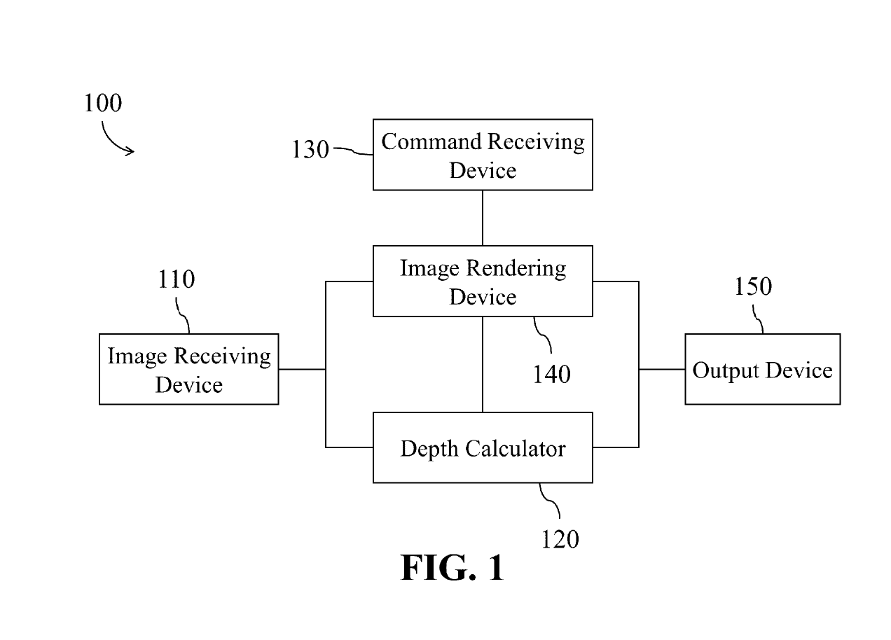

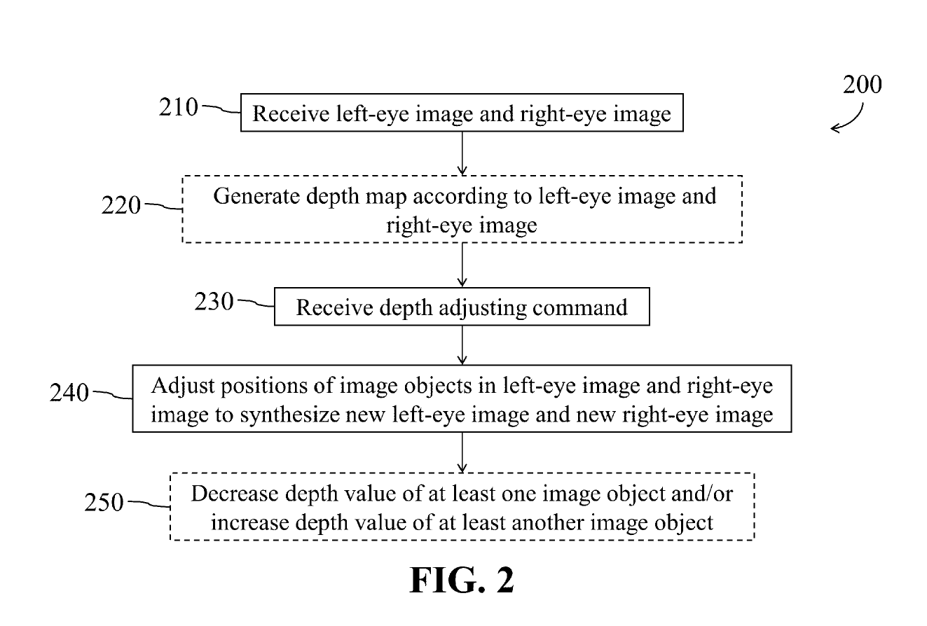

FIG. 1 is a simplified functional block diagram of a 3D image rendering apparatus 100 according to an example embodiment. The 3D image rendering apparatus 100 comprises an image receiving device 110, a depth calculator 120, a command receiving device 130, an image rendering device 140, and an output device 150. In implementations, different functional blocks of the 3D image rendering apparatus 100 may be respectively realized by different circuit components. Alternatively, some or all functional blocks of the 3D image rendering apparatus 100 may be integrated into a single circuit chip. The operations of the 3D image rendering apparatus 100 will be further described with reference to FIG. 2 through FIG. 5.

FIG. 2 is a simplified flowchart 200 illustrating a method for rendering 3D image in accordance with an example embodiment. In operation 210, the image receiving device 110 receives a left-eye image and a right-eye image capable of forming a 3D image from an image data source (not shown). The image data source may be any device capable of providing left-eye 3D image data and right-eye 3D image data, such as a computer, a DVD player, a signal wire of a cable TV, an Internet device, or a mobile computing device. In this embodiment, the image data source needs not to transmit depth map data to the image receiving device 110.

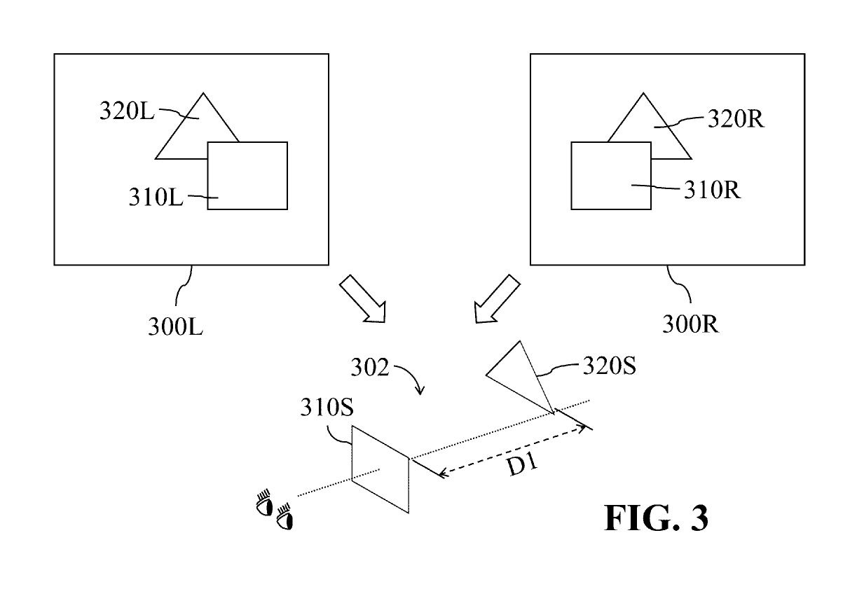

For the purpose of explanatory convenience in the following description, it is assumed that a left-eye image 300L and a right-eye image 300R as shown in FIG. 3 are received by the image receiving device 110 in operation 210. When the left-eye image 300L and the right-eye image 300R are displayed by a display device (not shown), the left-eye image 300L and the right-eye image 300R are capable of forming a 3D image 302. In this embodiment, an image object 310L of the left-eye image 300L and an image object 310R of the right-eye image 300R form a 3D image object 310S in the 3D image 302, and the image object 320L of the left-eye image 300L and the image object 320R of the right-eye image 300R form another 3D image object 320S behind the 3D image object 310S in the 3D image 302. In practical applications, the afore-mentioned display device may be a glasses-free 3D display device adopting auto-stereoscopic technology or a 3D display device that cooperates with specialized glasses or helmet when displaying 3D images.

In operation 220, the depth calculator 120 generates one or more corresponding depth maps according to the left-eye image 300L and the right-eye image 300R. The outline of each image object may be recognized by human eyes. In most application environments, however, the aforementioned image data source does not provide reference data of image objects, such as shape and position, to the 3D image rendering apparatus 100. In such case, the depth calculator 120 may perform image edge detection or image recognition operation on pixel values of the left-eye image 300L and the right-eye image 300R to recognize corresponding image objects in the left-eye image 300L and the right-eye image 300R.

The term “pixel value” as used herein refers to luminance, chrominance, or other characteristic value of the pixel that can be utilized to perform edge detection or motion detection. In addition, the term “corresponding image objects” as used herein refers to an image object in the left-eye image and an image object the right-eye image that represent the same physical object. Please note that the corresponding image objects in the left-eye image and the right-eye image may not completely identical to each other as the two image objects may have a slight position difference due to the camera angle or due to the parallax process. Accordingly, when a particular image object in the left-eye image is very similar to an image object in the right-eye image, for example, when the sum of pixel value difference of the two image objects is lower than a predetermined value, the depth calculator 120 may determine that the two image objects are corresponding image objects. Alternatively, the depth calculator 120 may determine that a particular image object in the left-eye image and an image object in the right-eye image are corresponding image objects when they are very similar to each other and are both located in the same (or almost the same) horizontal belt area. In implementations, the depth calculator 120 may identify corresponding image objects in the left-eye image 300L and the right-eye image 300R by using other image detection methods or algorithms.

Then, the depth calculator 120 determines the position difference between the corresponding image objects of the left-eye image 300L and the right-eye image 300R to calculate a depth value for the corresponding image objects. Relatively-lighter depth represents that the image object is closer to the video camera (or the observer), and relatively-greater depth represents that the image object is further away from the video camera (or the observer). Assuming that the depth calculator 120 determines that the image object 310L of the left-eye image 300L and the image object 310R of the right-eye image 300R are corresponding image objects according to the results of edge detection or image recognition operation described previously, the depth calculator 120, in the operation 220, calculates the position difference between the image object 310L and the image object 310R, and derives a depth value for the image object 310L and the image object 310R according to the resulting position difference.

For example, the depth calculator 120 may calculate the pixel distance between a reference point of the image object 310L, such as the centroid, and the left boundary of the left-eye image 300L to generate a position value PL1, and calculate the pixel distance between the reference point of the image object 310R, i.e., the centroid in this case, and the right boundary of the right-eye image 300R to generate a position value PR1. In one embodiment, if the sum of the position values PL1 and PR1 is greater than a first predetermined value TH1, the depth calculator 120 determines that the depth of the image object 310L and the image object 310R is within a segment closer to the observer. That is, the depth of the 3D image object 310S in the 3D image 302 formed by the image object 310L and the image object 310R is within a segment closer to the observer. Accordingly, the depth calculator 120 assigns a relatively-larger depth value for pixels corresponding to the image object 310L in the left-eye image 300L, and/or assigns a relatively-larger depth value for pixels corresponding to the image object 310R in the right-eye image 300R. In this embodiment, a relatively-larger depth value corresponds to relatively-lighter depth, i.e., it means that the image object is closer to the video camera (or the observer). On the contrary, a relatively-smaller depth value corresponds to relatively-greater depth, i.e., it means that the image object is further away from the video camera (or the observer).

Similarly, assuming that the depth calculator 120 determines that the image object 320L of the left-eye image 300L and the image object 320R of the right-eye image 300R are corresponding image objects according to the results of edge detection or image recognition operation described previously, the depth calculator 120, in the operation 220, calculates the position difference between the image object 320L and the image object 320R, and derives a depth value for the image object 320L and the image object 320R according to the resulting position difference. For example, the depth calculator 120 may calculate the pixel distance between a reference point of the image object 320L and the left boundary of the left-eye image 300L to generate a position value PL2, and calculate the pixel distance between the reference point of the image object 320R and the right boundary of the right-eye image 300R to generate a position value PR2. In this embodiment, if the sum of the position values PL2 and PR2 is less than a second predetermined value TH2, which is less than the first predetermined value TH1, the depth calculator 120 determines that the depth of the image object 320L and the image object 320R is within a segment further away from the observer. That is, the depth of the 3D image object 320S in the 3D image 302 formed by the image object 320L and the image object 320R is within a segment further away from the observer. Accordingly, the depth calculator 120 assigns a relatively-smaller depth value for pixels corresponding to the image object 320L in the left-eye image 300L, and/or assigns a relatively-smaller depth value for pixels corresponding to the image object 320R in the right-eye image 300R.

In implementations, the reference point of the image object may be replaced by a point in other position of the image object, such as a point in the upper left corner or the lower right corner of the image object.

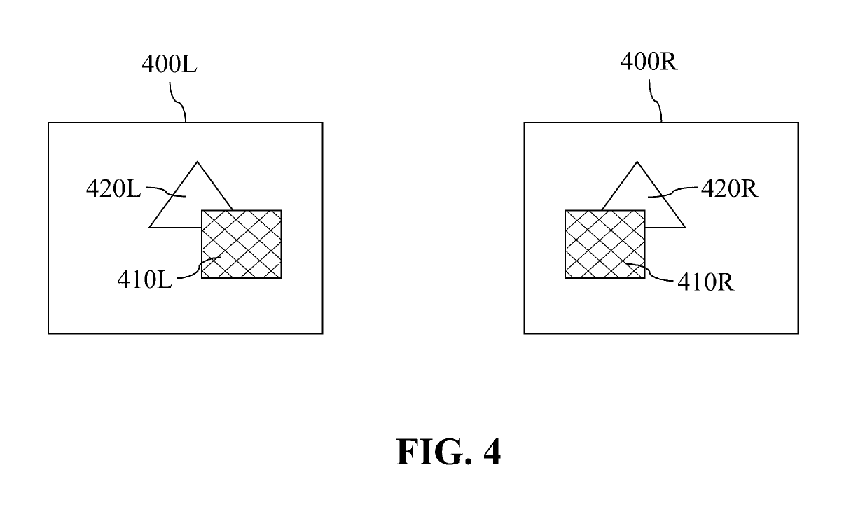

By performing the foregoing operations, the depth calculator 120 obtains the depth of a plurality of objects in the left-eye image 300L and the right-eye image 300R, and then generates a left-eye depth map 400L corresponding to the left-eye image 300L and/or a right-eye depth map 400R corresponding to the right-eye image 300R. An example embodiment of the left-eye depth map 400L and the right-eye depth map 400R are shown in FIG. 4. The pixel area 410L and the pixel area 420L of the left-eye depth map 400L correspond to the image object 310L and the image object 320L of the left-eye image 300L, respectively. Similarly, the pixel area 410R and the pixel area 420R of the right-eye depth map 400R correspond to the image object 310R and the image object 320R of the right-eye image 300R, respectively. For the purpose of explanatory convenience in the following description, it is assumed herein that the depth calculator 120 of this embodiment sets the depth value of pixels in the pixel areas 410L and 410R to be 200 and sets the depth value of pixels in the pixel areas 420L and 420R to be 60.

In order to allow the observer of the 3D images to adjust the depth of the 3D images depending upon the observer's visual condition or requirement, the 3D image rendering apparatus 100 allows the observer to adjust the depth of 3D images through a remote control or other control interface so as to provide better viewing experience to the observer with improved viewing quality and comfort. Therefore, the command receiving device 130 receives a depth adjusting command from a remote control or other control interface operated by the user in operation 230.

Then, the image rendering device 140 performs operation 240 to adjust positions of image objects in the left-eye image 300L and the right-eye image 300R according to the depth adjusting command to generate a new left-eye image and a new right-eye image for forming a new 3D image with adjusted depth configuration.

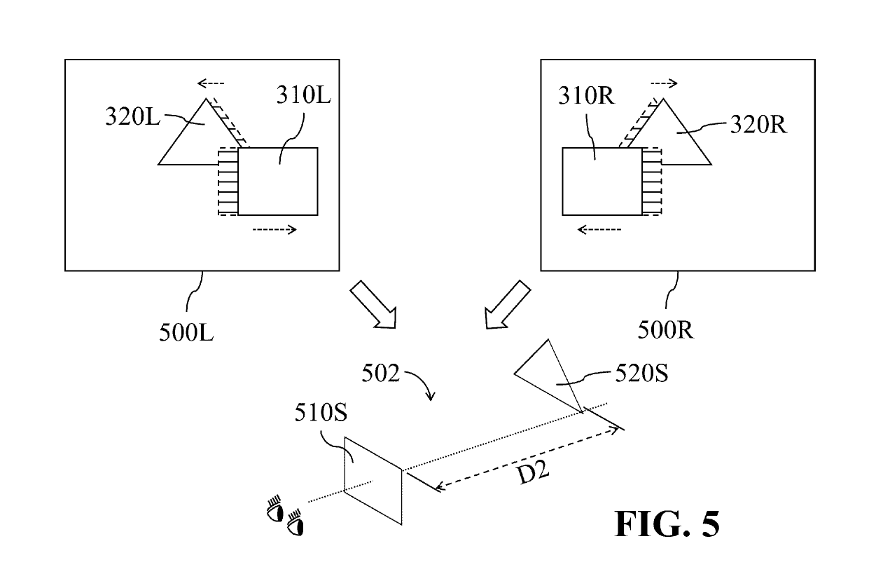

For the purpose of explanatory convenience in the following description, it is assumed herein that the depth adjusting command is intended to enhance the stereo effect of the 3D images, i.e., to enlarge the depth difference between different image objects of the 3D image. In this embodiment, the image rendering device 140 adjusts the positions of the image objects 310L and 320L of the left-eye image 300L and the image objects 310R and 320R of the right-eye image 300R according to the depth adjusting command, to generate a new left-eye image 500L and a new right-eye image 500R as shown in FIG. 5. In this embodiment, the image rendering device 140 moves the image object 310L rightward and moves the image object 320L leftward when generating the new left-eye image 500L. The image rendering device 140 moves the image object 310R leftward and moves the image object 320R rightward when generating the new right-eye image 500R. In implementations, the moving direction of each image object is relevant to the depth adjusting direction indicated by the depth adjusting command, and the moving distance of each image object is relevant to the degree of depth adjustment indicated by the depth adjusting command and the original depth value of the image object.

The new left-eye image 500L and the new right-eye image 500R form a 3D image 502 when displayed by a display apparatus (not shown) of the subsequent stage. In this embodiment, the image object 310L of the left-eye image 500L and the image object 310R of the right-eye image 500R form a 3D image object 510S of the 3D image 502, and the image object 320L of the left-eye image 500L and the image object 320R of the right-eye image 500R form a 3D image object 520S of the 3D image 502 when displaying. According to the adjusting directions of image objects described previously, the depth of the 3D image object 510S in the 3D image 502 is greater than the depth of the 3D image object 310S in the 3D image 302. That is, the observer would perceive that the 3D image object 510S is closer to him/her than the 3D image object 310S. On the other hand, the depth of the 3D image object 520S in the 3D image 502 is lighter than the depth of the 3D image object 320S in the 3D image 302. That is, the observer would normally perceive that the 3D image object 520S is further away from him/her than the 3D image object 310S.

As a result, assuming that the depth value distance between the 3D image objects 310S and 320S in the 3D image 302 perceived by the observer is D1, the depth value distance between the 3D image objects 510S and 520S in the new 3D image 502 perceived by the observer would become D2, which is greater than the depth value distance D1.

The foregoing operations of generating the new left-eye image 500L and the new right-eye image 500R by moving image objects may result in void image areas in the edge portion of the image objects. To improve the quality of 3D images, the image rendering device 140 may generate data required for filling the void image areas of the left-eye image according to a portion of data of the right-eye image, and generate data required for filling the void image areas of the right-eye image according to a portion of data of the left-eye image.

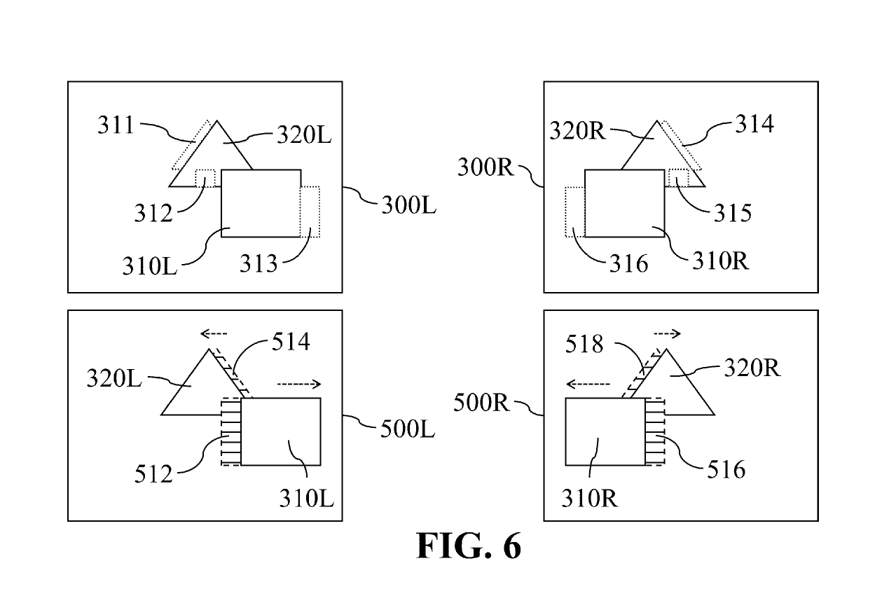

FIG. 6 is a simplified schematic diagram illustrating the operation of filling void image areas in the left-eye image and the right-eye image according to an example embodiment. As described previously, the image rendering device 140 moves the image object 310L rightward and moves the image object 320L leftward when generating the new left-eye image 500L, and moves the image object 310R leftward and moves the image object 320L rightward when generating the new right-eye image 500R. The foregoing moving operation of image objects may result in a void image area 512 in the edge of the image object 310L, a void image area 514 in the edge of the image object 320L, a void image area 516 in the edge of the image object 310R, and a void image area 518 in the edge of the image object 320R. In this embodiment, the image rendering device 140 may fill the void image area 512 of the new left-eye image 500L with pixel values of the image areas 315 and 316 of the original right-eye image 300R, and may fill the void image area 514 of the new left-eye image 500L with pixel values of the image area 314 of the original right-eye image 300R. Similarly, the image rendering device 140 may fill the void image area 516 of the new right-eye image 500R with pixel values of the image areas 312 and 313 of the original left-eye image 300L, and may fill the void image area 518 of the new right-eye image 500R with pixel values of the image area 311 of the original left-eye image 300L.

In implementations, the image rendering device 140 may perform interpolation operations to generate new pixel values required for filling the void image areas of the new left-eye image 500L and the new right-eye image 500R by referencing to the pixel values of the original left-eye image 300L and the original right-eye image 300R.

Some traditional image processing methods utilize a 2D image of a single viewing angle (such as one of the left-eye image and the right-eye image) to generate image data of another viewing angle. In such case, when the image objects of the single viewing angle are moved, it is difficult to effectively fill the resulting void image areas, thereby degrading the image quality in the edges of the image objects. In comparison with the traditional methods, the disclosed image rendering device 140 generates new left-eye image and right-eye image using reciprocal image data of the original right-eye image and left-eye image. In this way, the image quality of 3D images can be effectively improved, especially in the edge portions of image objects.

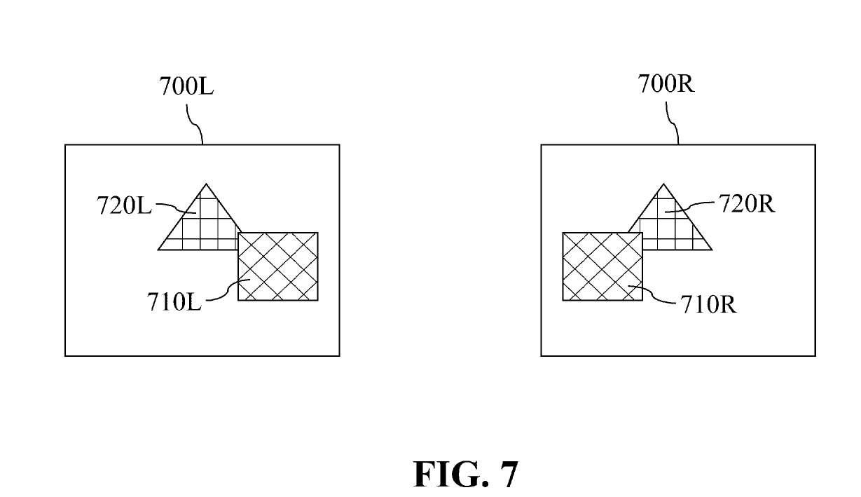

In operation 250, the image rendering device 140 decreases the depth value of at least one image object and/or increases the depth value of at least one of other image objects according to the depth adjusting command. For example, in the embodiment shown in FIG. 7, the image rendering device 140 may increase the depth value of pixels in the pixel areas 710L and 710R corresponding to the image objects 310L and 310R to be 240, and decrease the depth value of pixels in the pixel areas 720L and 720R corresponding to the image objects 320L and 320R to be 40, to generate a left-eye depth map 700L corresponding to the new left-eye image 500L and/or a right-eye depth map 700R corresponding to the new right-eye image 500R.

Then, depending upon the design of circuit in the subsequent stage, the output device 150 may transmit the new left-eye image 500L and the new right-eye image 500R generated by the image rendering device 140 as well as the adjusted left-eye depth map 700L and/or the right-eye depth map 700R to the circuit in the subsequent stage for displaying or further processing.

If the depth adjusting command received by the command receiving device 130 is intended to degrade the stereo effect of the 3D images, i.e., to reduce the depth difference between different image objects of the 3D image, the image rendering device 140 may perform the previous operation 240 in opposite direction. For example, the image rendering device 140 may move the image object 310L leftward and move the image object 320L rightward when generating the new left-eye image. The image rendering device 140 may move the image object 310R rightward and move the image object 320R leftward when generating the new right-eye image. As a result, the depth difference between a new 3D image object formed by the image objects 310L and 310R and another new 3D image formed by the image objects 320L and 320R can be reduced. Similarly, the image rendering device 140 may perform the previous operation 250 in opposite direction.

Please note that in the foregoing embodiments, the image rendering device 140 adjusts the position and depth of the image object 310L in opposite direction to the image object 320L, and adjusts the position and depth of the image object 310R in opposite direction to the image object 320R according to the depth adjusting command. This merely an example rather than a restriction to the practical applications. In implementations, the image rendering device 140 may adjust the position and/or depth value of only a portion of image objects while maintaining the position and/or depth value of other image objects.

For example, when the depth adjusting command requests the 3D image rendering apparatus 100 to enhance the stereo effect of 3D images, the image rendering device 140 may only move the image object 310L rightward and move the image object 310R leftward, but not changing the positions and depth values of the image objects 320L and 320R. Alternatively, the image rendering device 140 may only move the image object 320L leftward and move the image object 320R rightward, but not changing the positions and depth values of the image objects 310L and 310R. The above two adjustments can both increase the depth difference between different image objects of the 3D image.

Alternatively, the image rendering device 140 may only increase the depth values of the image objects 310L and 310R, but not changing the depth values and positions of the image objects 320L and 320R. On the contrary, the image rendering device 140 may only decrease the depth values of the image objects 320L and 320R, but not changing the depth values and positions of the image objects 310L and 310R. The above two adjustments can both increase the depth difference between different image objects of the 3D image.

In another embodiment, the image rendering device 140 may move the image object 310L and the image object 320L toward the same direction with different distance when generating the new left-eye image 500L, and move the image object 310R and the image object 320R toward another direction with different distance when generating the new right-eye image 500R. In this way, the image rendering device 140 could also change the depth difference between different image objects of the 3D image.

In another embodiment, the image rendering device 140 may change the depth difference between different image objects of the 3D image by adjusting the depth values of pixels corresponding to the image objects 310L, 320L, 310R, and 320R toward the same direction with different adjusting amounts. For example, the image rendering device 140 may increase the depth values of pixels corresponding to the image objects 310L, 320L, 310R, and 320R, but the depth value increments of pixels of the image objects 310L and 310R are greater than the depth value increments of pixels of the image objects 320L and 320R, to enlarge the depth difference between different image objects of the 3D image. In another example, the image rendering device 140 may decrease the depth values of pixels corresponding to the image object 310L, 320L, 310R, and 320R, but the depth value decrements of pixels of the image objects 310L and 310R are greater than the depth value decrements of pixels of the image objects 320L and 320R, to reduce the depth difference between different image objects of the 3D image.

The execution order of the operations in the previous flowchart 200 is merely an example, rather than a restriction to the practical implementations. For example, in another embodiment, the image rendering device 140 may perform the operation 250 first to adjust the depth values of image objects according to the depth adjusting command and then perform the operation 240 to calculate corresponding moving distance of each image object according to the adjusted depth value and move the image objects accordingly. That is, the execution order of operations 240 and 250 may be swapped. Additionally, one of the operations 240 and 250 may be omitted in some embodiments.

In addition to allow the observer to adjust the stereo effect of 3D images, i.e., the depth difference between different 3D image objects, as needed, the disclosed 3D image rendering apparatus 100 is capable of supporting glasses-free multi-view auto stereo display application. As elaborated previously, the depth calculator 120 is able to generate corresponding left-eye depth map 400L and/or right-eye depth map 400R according to the received left-eye image 300L and right-eye image 300R. The image rendering device 140 may synthesize a plurality of left-eye images and a plurality of right-eye images respectively corresponding to a plurality of viewing points according to the left-eye image 300L, the right-eye image 300R, the left-eye depth map 400L, and/or the right-eye depth map 400R. The output device 150 may transmit the generated left-eye images and right-eye images to an appropriate display device to achieve the glasses-free multi-view auto stereo display function.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A 3D image rendering apparatus comprising:
an image receiving device for receiving a first left-eye image and a first right-eye image capable of forming a first 3D image, wherein a first image object of the first left-eye image and a second image object of the first right-eye image are for forming a first 3D image object in the first 3D image, and a third image object of the first left-eye image and a fourth image object of the first right-eye image are for forming a second 3D image object in the first 3D image;
a command receiving device for receiving a depth adjusting command; and
an image rendering device, coupled with the command receiving device, for adjusting positions of the first, second, third, and fourth image objects according to the depth adjusting command to generate a second left-eye image and a second right-eye image for forming a second 3D image, so that the first image object and the second image object forms a third 3D image object in the second 3D image, and the third image object and the fourth image object forms a fourth 3D image object in the second 3D image;
wherein depth of the third 3D image object in the second 3D image is greater than depth of the first 3D image object in the first 3D image, and depth of the fourth 3D image object in the second 3D image is lighter than depth of the second 3D image object in the first 3D image.

2. The 3D image rendering apparatus of claim 1, wherein the image rendering device moves the first image object rightward and moves the third image object leftward when generating the second left-eye image, and the image rendering device moves the second image object leftward and moves the fourth image object rightward when generating the second right-eye image.

3. The 3D image rendering apparatus of claim 2, wherein the image rendering device generates a portion of data of the second left-eye image according to a portion of data of the first right-eye image, and generates a portion of data of the second right-eye image according to a portion of data of the first left-eye image.

4. The 3D image rendering apparatus of claim 1, further comprising:
a depth calculator, coupled with the image receiving device, for generating at least one of a left-eye depth map and a right-eye depth map according to the first left-eye image and the first right-eye image.

5. The 3D image rendering apparatus of claim 4, wherein the depth calculator determines a position difference between the first image object in the first left-eye image and the second image object in the first right-eye image to calculate depth values for the first image object and the second image object, and the depth calculator determines a position difference between the third image object in the first left-eye image and the fourth image object in the first right-eye image to calculate depth values for the third image object and the fourth image object.

6. The 3D image rendering apparatus of claim 5, wherein the image rendering device increases a portion of depth values corresponding to the first image object in the left-eye depth map, decreases a portion of depth values corresponding to the third image object in the left-eye depth map, increases a portion of depth values corresponding to the second image object in the right-eye depth map, and decreases a portion of depth values corresponding to the fourth image object in the right-eye depth map according to the depth adjusting command.

7. A 3D image rendering apparatus comprising:
an image receiving device for receiving a first left-eye image and a first right-eye image capable of forming a first 3D image, wherein a first image object of the first left-eye image and a second image object of the first right-eye image are for forming a first 3D image object in the first 3D image, and a third image object of the first left-eye image and a fourth image object of the first right-eye image are for forming a second 3D image object in the first 3D image;
a command receiving device for receiving a depth adjusting command; and
an image rendering device, coupled with the command receiving device, for adjusting positions of only a portion of image objects in the first left-eye image and the first right-eye image according to the depth adjusting command to generate a second left-eye image and a second right-eye image for forming a second 3D image, so that the first image object and the second image object forms a third 3D image object in the second 3D image, and the third image object and the fourth image object forms a fourth 3D image object in the second 3D image;
wherein depth of the third 3D image object in the second 3D image is different from depth of the first 3D image object in the first 3D image, and depth of the fourth 3D image object in the second 3D image is equal to depth of the second 3D image object in the first 3D image.

8. The 3D image rendering apparatus of claim 7, wherein the image rendering device generates a portion of data of the second left-eye image according to a portion of data of the first right-eye image, and generates a portion of data of the second right-eye image according to a portion of data of the first left-eye image.

9. The 3D image rendering apparatus of claim 8, wherein the image rendering device moves the first image object rightward when generating the second left-eye image, and the image rendering device moves the second image object leftward when generating the second right-eye image.

10. The 3D image rendering apparatus of claim 8, wherein the image rendering device moves the first image object leftward when generating the second left-eye image, and the image rendering device moves the second image object rightward when generating the second right-eye image.

11. The 3D image rendering apparatus of claim 8, further comprising:
a depth calculator, coupled with the image receiving device, for generating at least one of a left-eye depth map and a right-eye depth map according to the first left-eye image and the first right-eye image.

12. The 3D image rendering apparatus of claim 11, wherein the depth calculator determines a position difference between the first image object in the first left-eye image and the second image object in the first right-eye image to calculate depth values for the first image object and the second image object, and the depth calculator determines a position difference between the third image object in the first left-eye image and the fourth image object in the first right-eye image to calculate depth values for the third image object and the fourth image object.

13. A 3D image rendering apparatus comprising:
an image receiving device for receiving a left-eye image and a right-eye image;
a depth calculator, coupled with the image receiving device, for generating a depth map according to the left-eye image and the right-eye image; and
an image rendering device for synthesizing a plurality of left-eye images and a plurality of right-eye images respectively corresponding to a plurality of viewing points according to the left-eye image, the right-eye image, and the depth map.

14. A 3D image rendering apparatus comprising:
an image receiving device for receiving a left-eye image and a right-eye image;
a depth calculator, coupled with the image receiving device, for generating at least one of a left-eye depth map and a right-eye depth map according to the left-eye image and the right-eye image;
a command receiving device for receiving a depth adjusting command; and
an image rendering device, coupled with the command receiving device, for increasing a depth value of a first pixel in at least one of the left-eye depth map and the right-eye depth map and for reducing a depth value of a second pixel in at least one of the left-eye depth map and the right-eye depth map.

15. The 3D image rendering apparatus of claim 14, wherein the depth calculator determines a position difference between the first image object in the left-eye image and the second image object in the right-eye image to calculate a depth value for the first pixel, and the depth calculator determines a position difference between the third image object in the left-eye image and the fourth image object in the right-eye image to calculate a depth value for the second pixel.

16. A 3D image rendering apparatus comprising:
an image receiving device for receiving a first left-eye image and a first right-eye image capable of forming a first 3D image, wherein a first image object of the first left-eye image and a second image object of the first right-eye image are for forming a first 3D image object in the first 3D image, and a third image object of the first left-eye image and a fourth image object of the first right-eye image are for forming a second 3D image object in the first 3D image;
a command receiving device for receiving a depth adjusting command; and
an image rendering device, coupled with the command receiving device, for adjusting positions of at least a portion of image objects in the first left-eye image and the first right-eye image according to the depth adjusting command to generate a second left-eye image and a second right-eye image for forming a second 3D image, so that the first image object and the second image object forms a third 3D image object in the second 3D image, and the third image object and the fourth image object forms a fourth 3D image object in the second 3D image;
wherein depth difference between the third 3D image object and the fourth 3D image object in the second 3D image is different from depth difference between the first 3D image object and the second 3D image object in the first 3D image.

17. The 3D image rendering apparatus of claim 16, wherein the image rendering device moves the first image object and the third image object toward a direction with different distances when generating the second left-eye image, and the image rendering device moves the second image object and the fourth image object toward another direction with different distances when generating the second right-eye image.

18. A 3D image rendering apparatus comprising:
an image receiving device for receiving a left-eye image and a right-eye image;
a depth calculator, coupled with the image receiving device, for generating at least one of a left-eye depth map and a right-eye depth map according to the left-eye image and the right-eye image;
a command receiving device for receiving a depth adjusting command; and
an image rendering device, coupled with the command receiving device, for adjusting depth values of at least a portion of pixels in the left-eye depth map and the right-eye depth map so that a change in depth value of a first pixel in at least one of the left-eye depth map and the right-eye depth map is different from that of a second pixel in at least one of the left-eye depth map and the right-eye depth map.

19. The 3D image rendering apparatus of claim 18, wherein the depth calculator determines a position difference between the first image object in the left-eye image and the second image object in the right-eye image to calculate a depth value for the first pixel, and the depth calculator determines a position difference between the third image object in the left-eye image and the fourth image object in the right-eye image to calculate a depth value for the second pixel.
